(19) United States
(12) Patent Application Publication
(10) Pub. No.: US 2026/0194849 A1
(43) Pub. Date: Jul. 9, 2026

(54) POST-PROCESSING APPARATUS AND IMAGE FORMING SYSTEM

(71) Applicant: Yuji SUSAKI, Gifu (JP)

(72) Inventor: Yuji SUSAKI, Gifu (JP)

(73) Assignee: ETRIA CO., LTD., Yokohama (JP)

(21) Appl. No.: 19/392,603

(22) Filed: Nov. 18, 2025

(30) Foreign Application Priority Data
Jan. 7, 2025 (JP) 2025-002139

(51) Int. Cl. G03G 15/00; B31F 5/00

(52) U.S. Cl. CPC G03G 15/6544; B31F 5/005; G03G 2215/00848; G03G 2215/00877

(57) ABSTRACT

A post-processing apparatus includes a sheet binder to bind a sheet bundle including a sheet to perform a sheet binding operation. The sheet binder includes a sheet folder to fold a part of the sheet to form a folded portion on the sheet of the sheet bundle.

### CROSS-REFERENCE TO RELATED APPLICATION

This patent application is based on and claims priority pursuant to 35 U.S.C. § 119(a) to Japanese Patent Application No. 2025-002139, filed on Jan. 7, 2025, in the Japan Patent Office, the entire disclosure of which is hereby incorporated by reference herein.

### BACKGROUND

### Technical Field

Embodiments of the present disclosure relate to a post-processing apparatus that includes a sheet binder to perform a binding operation as a post-processing operation on a sheet, and an image forming system that includes an image forming apparatus such as copier, printer, facsimile machine, printing machine, or multi-functional apparatus having at least two functions of the copier, the printer, and the facsimile machine.

### Related Art

Various types of post-processing apparatuses in the art are coupled to an image forming apparatus such as copier or printer to perform a binding operation on a sheet bundle of multiple sheets.

A post-processing apparatus in the art has disclosed a configuration that includes a dedicated sheet corner folding mechanism for the purpose of folding the corner of a sheet to be used as an index and a technique of forming the folded portion at the corner of a sheet.

### SUMMARY

Embodiments of the present disclosure described herein provide a novel medium processing apparatus including a sheet binder to bind a sheet bundle including a sheet to perform a sheet binding operation. The sheet binder includes a sheet folder to fold a part of the sheet to form a folded portion on the sheet of the sheet bundle.

Further, embodiments of the present disclosure described herein provide an image forming system including an image forming apparatus to form an image on a sheet, and the above-described post-processing apparatus to perform a sheet binding operation on the sheet on which the image is formed by the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system according to an embodiment of the present disclosure;

FIG. 2 is a diagram illustrating a post-processing apparatus;

FIG. 3 is a diagram illustrating a sheet binder;

FIG. 4 is a top view of a sheet binder in a state where a corner of a sheet (or a sheet bundle) is inserted to an insertion portion of the sheet binder;

FIGS. 5A, 5B and 5C are diagrams illustrating an operation of forming a folded portion on a sheet by the sheet binder;

FIG. 6A is a top view of a sheet with a folded portion;

FIG. 6B is a side view of sheets with folded portions each used as an index for sorting multiple sheet bundles;

FIG. 7 is a flowchart of an example of a control mode (edge folding mode) for forming a folded portion on a sheet;

FIG. 8 is a block diagram illustrating a control system of an image forming system;

FIG. 9 is a block diagram illustrating a control system of a post-processing apparatus;

FIGS. 10A and 10B are top views of a sheet binder in a state where a corner of a sheet (or a sheet bundle) is inserted to an insertion portion of the sheet binder according to Modification 1;

FIG. 11 is an enlarged view of a stapleless sheet binder according to Modification 2 in a state where paired tooth-shaped members in the stapleless sheet binder are engaged with each other;

FIG. 12A is a side view of the stapleless sheet binder of FIG. 11 in a state where the corner of a sheet is folded back by the stapleless sheet binder;

FIG. 12B is a side view of the stapleless sheet binder of FIG. 11 in a state where the folded portion of the sheet is formed;

FIG. 13A is a side view of a stapleless sheet binder according to Modification 3 in a state where the corner of a sheet is folded back by the stapleless sheet binder;

FIG. 13B is a side view of the stapleless sheet binder according to Modification 3 in a state where the folded portion of the sheet is formed; and

FIG. 14 is a cross-sectional view of an insertion portion of the stapleless sheet binder of FIGS. 13A and 13B viewed from above.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

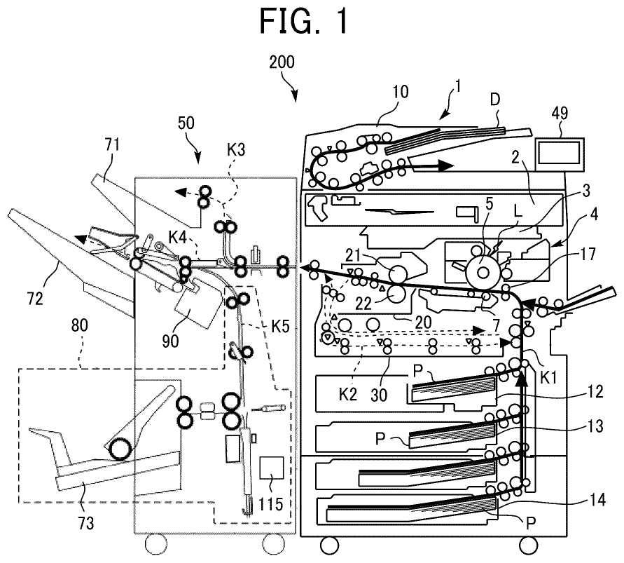

A description is given of the overall configuration and operations of an image forming system 200 with reference to FIG. 1.

FIG. 1 is a diagram illustrating an overall configuration of an image forming system according to an embodiment of the present disclosure.

In the present embodiment, an image forming apparatus 1 is provided with a post-processing apparatus 50 that is detachably attached to the image forming apparatus 1. The image forming apparatus 1 and the post-processing apparatus 50 are included together in the image forming system 200.

In FIG. 1, the image forming apparatus 1 as a copier according to the present embodiment includes a document reader 2, a photoconductor drum 5, and an exposure device 3. The document reader 2 optically reads image data of an original document D. The exposure device 3 emits exposure light L, based on the image data read by the document reader 2, onto a surface of the photoconductor drum 5.

The image forming apparatus 1 further includes an image forming device 4, a transfer device (image forming device) 7, and a document conveyor 10. The image forming device 4 forms a toner image on the surface of the photoconductive drum 5. The transfer device 7 transfers the toner image formed on the photoconductor drum 5 onto a sheet P. The document conveyor 10 conveys the set original document D to the document reader 2. The image forming apparatus 1 further includes sheet trays 12, 13 and 14 and a registration roller pair (timing roller pair) 17. The sheet trays 12, 13 and 14 accommodate a sheet P such as paper. The registration roller pair (timing roller pair) 17 conveys the sheet P toward the transfer device 7.

The image forming apparatus 1 further includes a fixing device 20, a fixing roller 21, and a pressure roller 22. The fixing device 20 fixes an unfixed image on the sheet P to the sheet P. The fixing roller 21 and the pressure roller 22 are included in the fixing device 20.

The image forming apparatus 1 further includes a duplex conveyor 30 and an operation display panel 49. The duplex conveyor 30 reverses the sheet P after an image is formed on the front side and conveys the sheet P toward the image forming device. The operation display panel 49 displays information related to a printing operation (image forming operation) or a post-processing operation and allows the printing operation or the post-processing operation to be operated.

The image forming apparatus 1 further includes the post-processing apparatus 50, a first ejection tray 71, a second ejection tray 72, a third ejection tray 73, a bookbinder 80, and a sheet binder 90. The post-processing apparatus 50 performs a post-processing operation on the sheet P ejected from the image forming apparatus 1 and conveyed to the post-processing apparatus 50. Each of the first ejection tray 71, the second ejection tray 72, and the third ejection tray 73 stacks the sheet P (or the sheet bundle) after the post-processing operation. The bookbinder 80 and the sheet binder 90 are included in the post-processing apparatus 50.

A description is given of the operation during a regular image forming operation (printing operation) of the image forming apparatus 1 (of the image forming system 200), with reference to FIG. 1.

The original document D is conveyed by a conveyance roller of the document reader 2 of the document conveyor 10 from a document loading table of the document conveyor 10 in a direction indicated by arrow in FIG. 1, and passes over the document reader 2. At this time, the document reader 2 optically reads image data of the original document D passing over the document reader 2.

The image data optically read by the document reader 2 is converted into electrical signals. The electrical signals are transmitted to the exposure device 3 (writing part). The exposure device 3 then emits the exposure light L such as laser light according to the image data of the electrical signals toward the surface of the photoconductor drum 5 of the image forming device 4.

Meanwhile, while the photoconductive drum 5 rotates in a clockwise direction in FIG. 1, the image forming device 4 performs a series of image forming processes, such as a charging process, an exposing process, and a developing process, to form a toner image corresponding to the image data on the photoconductive drum 5.

Then, the toner image formed on the surface of the photoconductor drum 5 is transferred by the transfer device 7 as an image forming device, onto the sheet P conveyed by the registration roller pair 17.

A description is now given of the sheet P that is conveyed to the transfer device 7 (image forming device).

First, one of the multiple sheet trays 12, 13 and 14 of the image forming apparatus 1 is selected automatically or manually. For example, the uppermost sheet tray 12 is selected. Then, the uppermost sheet of the sheets P accommodated in the sheet tray 12 is conveyed toward the position of a sheet conveyance path K1.

The uppermost sheet P (or the sheet P) passes through the sheet conveyance path K1, in which multiple sheet conveyance rollers are disposed, and then reaches the position of the registration roller pair 17. After having reached the position of the registration roller pair 17, the sheet P is conveyed toward the transfer device 7 (image formation device) in synchronization with movement of the toner image formed on the surface of the photoconductor drum 5 for positioning.

After the transfer device 7 transfers the toner image from the photoconductor drum 5 onto the sheet P in the transfer process, the sheet P passes the position of the transfer device 7 to be conveyed to the fixing device 20 along the sheet conveyance path. In the fixing device 20, the sheet P is conveyed between the fixing roller 21 and the pressure roller 22. The toner image on the sheet P is fixed to the sheet P by application of heat by the fixing roller 21 and pressure from the fixing roller 21 and the pressure roller 22. The sheet P to which the image is fixed is ejected from the image forming apparatus 1 after being conveyed out from between the fixing roller 21 and the pressure roller 22 (i.e., a nip portion).

The image forming apparatus 1 operates in various modes such as a “duplex print mode” in which an image is printed (formed) on both sides (i.e., the front side and the back side) of the sheet P and a “single-side print mode” in which an image is printed (formed) on one side (i.e., the front side) of the sheet P. Unlike the above-described “single-side print mode”, when the “duplex print mode” is selected, the sheet P after the fixing process on the front side is completed is not ejected but is guided to a duplex conveyance path K2. Subsequently, the conveyance direction of the sheet P is reversed by the duplex conveyor 30, and then the sheet P is conveyed toward the position of the transfer device 7 (image forming device) again. Then, an image is formed on the back side of the sheet P by the same image forming process (image forming operation) as described above, at the position of the transfer device 7. Then, the sheet P is subjected to the fixing process in the fixing device 20, passes the conveyance path, and is ejected from the image forming apparatus 1.

In the present embodiment, the post-processing apparatus 50 is coupled to the image forming apparatus 1, and the sheet P ejected from the image forming apparatus 1 is conveyed to the post-processing apparatus 50, and the post-processing apparatus 1 performs a post-processing operation on the sheet P conveyed from the image forming apparatus 1.

Referring to FIG. 1, the post-processing apparatus 50 according to the present embodiment conveys the sheet P conveyed from the image forming apparatus 1 to a conveyance path of three conveyance paths, which are a first conveyance path K3, a second conveyance path K4 and a third conveyance path K5, so as to perform a different post-processing operation. The first conveyance path K3 is a conveyance path for ejecting the sheet P conveyed from the image forming apparatus 1 to the first ejection tray 71 as it is without performing a post-processing operation. The second conveyance path K4 is a conveyance path for stacking the sheets P conveyed from the image forming apparatus 1 onto the internal tray 61, performing a sheet binding operation on a sheet bundle PT including multiple sheets P by the sheet binder 90, and ejecting the sheets P (sheet bundle PT) subjected to the sheet binding operation, from an ejection port 50b toward the second ejection tray 72 by the ejection roller 54. The third conveyance path K5 is a conveyance path for conveying the sheet P conveyed from the image forming apparatus 1 to the second conveyance path K4 once to switch back the sheet P, then performing the saddle stitching operation on the sheet center portion of the sheet P by the saddle stitching device 81 of the bookbinder 80 and the center folding operation by the center folder 87, and placing the sheet P on the third ejection tray 73.

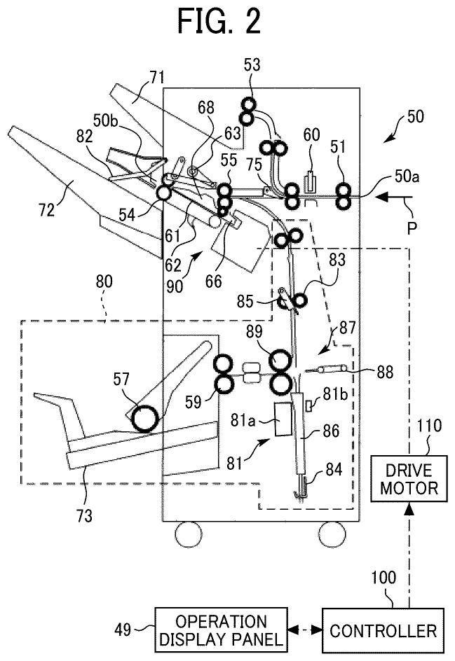

The switching of the three conveyance paths described above, which are the first conveyance path K3, the second conveyance path K4 and the third conveyance path K5, is performed by a switching operation (rotation) of the separation member 75 (see FIG. 2).

FIG. 2 is a diagram illustrating the post-processing apparatus 50.

More specifically, referring to FIG. 2, a first conveyance roller 51 (entrance roller) and a sheet detection sensor are installed in the vicinity of a sheet receiving port 50a of the post-processing apparatus 50, so that the sheet P detected by the sheet detection sensor is conveyed into the post-processing apparatus 50 by the first conveyance roller 51. Then, the separation member 75 is rotated so that the sheet P is guided to a desired conveyance path from the first conveyance path K3, the second conveyance path K4 and the third conveyance path K5 based on a post-processing mode selected by the user in advance.

When a mode in which the post-processing is not performed is selected, the sheet P conveyed to the first conveyance path K3 is ejected by the ejection roller pair 53 and is placed on the first ejection tray 71.

On the other hand, when a “hole punching operation (punching operation)” is selected on the operation display panel 49 by the user, as the sheet P passes a hole puncher 60, the punching operation is performed on the sheet P by the hole puncher 60.

When a “sorting mode (sorting processing mode)” is selected, the sheet P that is conveyed to the second conveyance path K4 is conveyed while being shifted in the width direction of the sheet P by a given amount for each sheet P by a shift roller pair 55 (second conveyance roller) that is movable in the width direction (i.e., a direction orthogonal to the drawing sheet of FIG. 2), and multiple sheets P are sequentially stacked on the second ejection tray 72 by the ejection roller 54.

Referring to FIG. 2, a feeler 82 is provided above the second ejection tray 72 so as to be rotatable about a support shaft at the upper end, and the second ejection tray 72 can be raised and lowered by a raising and lowering mechanism. Then, a sensor that is disposed in the vicinity of the support shaft of the feeler 82 detects a state where the center of the sheets P, which are sequentially stacked on the second ejection tray 72, in the conveyance direction contacts the feeler 82. Accordingly, the height of the sheets P stacked on the second ejection tray 72 is recognized. The vertical position of the second ejection tray 72 is adjusted in accordance with an increase or decrease in the number of sheets P stacked on the second ejection tray 72. Further, when the vertical position of the second ejection tray 72 reaches the lower limit position, it is determined that the number of sheets P stacked on the second ejection tray 72 reaches the upper limit (full), and a stop signal is transmitted from the post-processing apparatus 50 to the image forming apparatus 1 to stop the image forming operation.

Further, when a “binding mode (stapling mode)” is selected, the sheets P conveyed to the second conveyance path K4 are sequentially stacked on the internal tray 61 without being shifted by the shift roller pair 55. Then, each time a sheet P (or a sheet bundle PT) is placed on the internal tray 61, a tapping roller 63 disposed above the internal tray 61 is moved from a retracted position to a position where the tapping roller 63 contacts the uppermost sheet P (of the sheet bundle PT), and the and the tapping roller 63 is driven and rotated in the counterclockwise direction in FIG. 2. By so doing, the uppermost sheet P is conveyed (moved) toward an end fence 66. Thus, the trailing end (the trailing end in the conveyance direction) of the multiple sheets P (the sheet bundle PT) contacts the end fence 66, and the positions of the multiple sheets P (sheet bundle PT) in the conveyance direction are aligned.

At this time, each time a sheet P is placed on the internal tray 61 (or after the desired number of sheets P are placed on the internal tray 61), jogger fences 68 (side fences) disposed at both ends of the internal tray 61 in the width direction move in the width direction to nip the sheet P (sheet bundle PT). By so doing, the position of the sheet P (the sheet bundle PT) in the width direction is aligned. Then, a sheet binding operation is performed on the trailing end of the sheets P (sheet bundle PT) aligned in the sheet conveyance direction and the width direction by the sheet binder 90.

Then, the sheets P (sheet bundle PT) subjected to the sheet binding operation are conveyed obliquely upward along the sloped face of the internal tray 61 along with movement of an ejection member 62, and are ejected onto the second ejection tray 72 by the ejection roller 54.

Further, when the “bookbinding mode (saddle-stitching and center-folding mode)” is selected, referring to FIG. 2, the sheet P is first conveyed to the second conveyance path K4, is then switched back by reversely rotating the shift roller pair 55 with the trailing end of the sheet P being nipped by the shift roller pair 55, and is conveyed to the third conveyance path K5. Then, the sheet P conveyed to the third conveyance path K5 is conveyed to the position of the bookbinder 80 by multiple conveyance rollers. Specifically, the sheet P is conveyed to a position where the center of the sheet P faces the saddle stitching device 81 (in other words, a position where a sheet conveying guide plate functions as an internal tray). Then, after the desired number of sheets P (sheet bundle PT) are stacked at the position, the saddle stitching device 81 performs a sheet binding operation (saddle binding operation) on the center of the sheet bundle PT. Subsequently, the multiple sheets P (sheet bundle PT) subjected to the saddle binding operation is conveyed to a position where the center of the sheet bundle PT faces a folding blade 88 (center folder) along with the movement of aligners 84 and 85 by a movement mechanism.

At this time, the leading end of the sheet bundle PT contacts the end fence (aligner) 84, so as to align the position of the sheet bundle PT in the conveyance direction. Further, each time the sheet P is placed on the internal tray (or after the desired number of sheets P are stacked), side fences 86 provided at both ends of the internal tray in the width direction move in the width direction so as to nip the sheet P (sheet bundle PT), and the position of the sheet P (sheet bundle PT) in the width direction is aligned.

Then, the sheet bundle PT is pressed by a sheet folding roller pair 89 (conveyance rollers) while being nipped and conveyed with the folded portion (center) as a leading end in a state where the center of the sheet bundle PT is folded by the folding blade 88 moving to the left in FIG. 2, and thus the sheet folding operation (center folding operation) is performed. Then, the sheet bundle PT subjected to the center folding operation is conveyed by an ejection roller pair 59, and is placed on the third ejection tray 73. Like the second ejection tray 72, the third ejection tray 73 is also vertically movable by a raising and lowering mechanism, and is lowered according to the number of sheets of the sheet bundle PT stacked on the tray.

In this way, a series of operations in the bookbinding mode (the saddle-stitching and center-folding mode) is completed.

In the present embodiment, in addition to the “bookbinding mode” in which the saddle stitching is performed after the saddle binding, a “center folding mode” in which only the center folding is performed without performing the saddle stitching can be selected. In the present embodiment, in addition to the various post-processing modes described above, a “edge folding mode” in which a folded portion Pa′ (sheet edge folding) is formed at a corner portion of the sheet P′ by using the sheet binder 90 can be selected, which will be described in detail below with reference to FIGS. 4 to 7.

The modes related to the various post-processing operations described above are selected by the user's operations on the operation display panel 49 of the image forming apparatus 1.

The post-processing apparatus 50 executes the above-described various modes by the post-processing controller 100 installed in the post-processing apparatus 50 (or in the image forming apparatus 1).

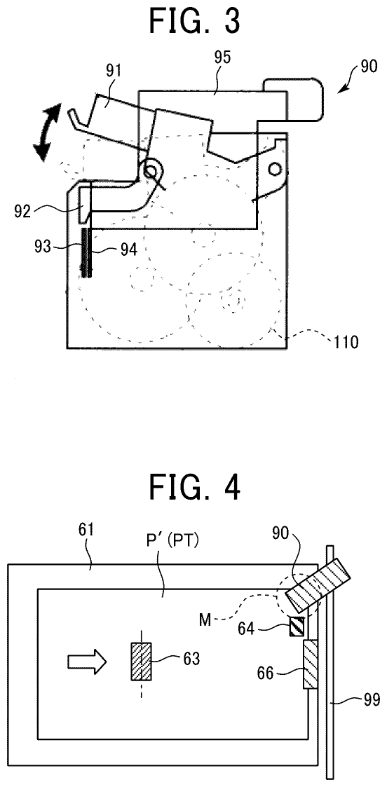

A description is given below of a configuration and operations of the sheet binder 90 in the binding mode, with reference to FIG. 3.

FIG. 3 is a diagram illustrating the sheet binder 90.

The sheet binder 90 according to the present embodiment uses metallic staples. Two tips of a staple sheet are constantly in a homing state (bent state), and the first tip is in close contact with a recess in a face plate 92 at the tip of a cartridge 95. Then, as the drive motor 110 (binding motor) drives, a driver plate 93 and a homing plate 94 provided close to the sheet binder 90 are simultaneously moved in a direction (clincher direction) to a clincher 91. The driver plate 93 pushes a first staple in the homing state in the clincher direction, and the homing plate 94 bends a third staple that is not homed (not bent). When the homing plate 94 bends the third staple, the third staple pushes the pusher of the tip of the cartridge 95 in a direction opposite to a feeding direction of the staple. Then, the driver plate 93 pushes the first staple to be driven into the sheet bundle PT. By so doing, the first staple is separated from the staple sheet, and at the same time, a gap for one staple is generated in the recess in the face plate 92. As a result, the pusher pushes a second staple in a direction of the face plate 92, and the second staple comes into close contact with the recess in the face plate 92. Accordingly, the staple driving operation is completed. The staple driven by the driver plate 93 is clinched by the clincher 91, and the sheet binding operation is completed.

The drive motor 110 provided in the sheet binder 90 is included in a driving mechanism together with multiple gears, and performs the operation (driving operation) of the sheet binder 90 as described above under the control of the post-processing controller 100.

A detailed description is given below of the configuration and operations of the post-processing apparatus 50 according to the present embodiment.

FIG. 4 is a top view of the sheet binder 90 in a state where a corner of a sheet (or a sheet bundle) is inserted to an insertion portion of the sheet binder 90.

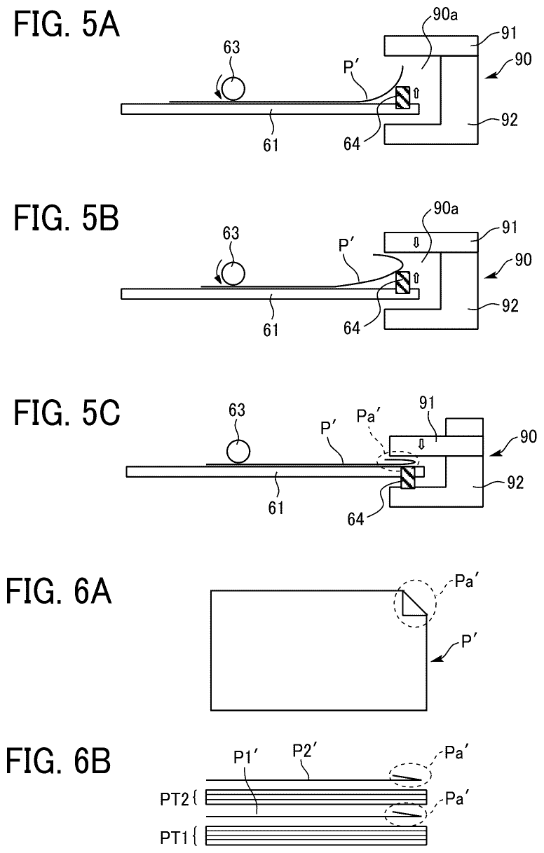

FIGS. 5A, 5B and 5C are diagrams illustrating an operation of forming a folded portion on a sheet by the sheet binder 90.

FIG. 6A is a top view of a sheet with a folded portion Pa.

FIG. 6B is a side view of sheets with folded portions Pa each used as an index for sorting multiple sheet bundles PT.

As described above with reference to FIGS. 1 to 3, the post-processing apparatus 50 according to the present embodiment includes the sheet binder 90 that performs the sheet binding operation on the sheet bundle PT including multiple sheets P.

The sheet binder 90 has an insertion portion 90a into which a processing object portion M (see FIG. 4) is inserted to perform the sheet binding operation on the processing object portion M of the sheet bundle PT. The insertion portion 90a is a space (opening) between the clincher 91 and the face plate 92 described with reference to FIG. 3 (FIGS. 5A and 5B) to accept a part of the sheet bundle PT inserted into the insertion portion 90a to perform the sheet binding operation.

Referring to FIGS. 5C and 6A, the post-processing apparatus 50 in the present embodiment forms a folded portion Pa′ in a part of the sheet P′ by the sheet binder 90 with respect to the sheet P′ (in other words, one sheet conveyed in the edge folding mode) conveyed toward the sheet binder 90.

Specifically, the sheet binder 90 performs a sheet binding operation on a sheet bundle PT at the corner. The sheet binder 90 according to the present embodiment is movable in the width direction along a guide rod 99 illustrated in FIG. 4 by a movement mechanism (e.g., a belt mechanism), so that the sheet binder 90 can perform a sheet binding operation on the sheet bundle PT at a given position in the width direction at the trailing end (i.e., the right end illustrated in FIG. 4) other than the corner.

The post-processing apparatus 50 according to the present embodiment forms a folded portion Pa′ (sheet edge folding) at the corner of the sheet P′ by the sheet binder 90 with respect to the sheet P′ conveyed toward the sheet binder 90.

The sheet P′ having the folded portion Pa′ (sheet edge folding) formed at the corner (a part) is mainly used as a sheet with an index. As an example, as illustrated in FIG. 6B, a sheet bundle PT1 and a sheet bundle PT2 are partitioned by a sheet P1′ as an index sheet, on which a folded portion Pa′ is formed or a sheet P2′ on which the folded portion Pa′ is formed as the front cover or the top sheet (or the back cover or the last sheet) of the sheet bundle PT2.

The “edge folding mode” in which the folded portion Pa′ (sheet edge folding) is formed at the corner of the sheet P′ by using the sheet binder 90 is selected by the operation of the user via the operation display panel 49 (see FIG. 1). At this time, the user designates, for example, the timing of insertion of the sheet P′ with the folded portion Pa′ being formed, with respect to multiple sheet bundles PT or multiple sheets P to be ejected onto the second ejection tray 72 in other various post-processing modes.

More specifically, as illustrated in FIGS. 4, 5A, 5B and 5C, the post-processing apparatus 50 according to the present embodiment includes a pushup member 64 as a sheet folder that folds back a part (corner) of the sheet P′ conveyed to the sheet binder 90 at the insertion portion 90a.

As illustrated in FIGS. 5A, 5B and 5C, the pushup member 64 pushes up the sheet P′ so as to change the conveyance direction of the sheet P′ to be inserted into the insertion portion 90a of the sheet binder 90, and bends a part (corner) of the sheet P′. Then, the sheet binder 90 presses the part (curved portion) folded back by the pushup member 64 (sheet folder) in the insertion portion 90a to form the folded portion Pa′.

In the present embodiment, the pushup member 64 is disposed on the internal tray 61 (in the vicinity of the sheet binder 90 located on one end in the width direction) so as to be raised and lowered by a raising and lowering mechanism. As illustrated in FIGS. 5A and 5B, the pushup member 64 is raised in the direction indicated by a white arrow when the corner of the sheet P′ is folded back, and is lowered so as not to hinder the pressing when the corner of the sheet P′ is pressed.

In the present embodiment, as illustrated in FIG. 5C, in the process of forming the folded portion Pa′ by pressing the corner (the folded portion) of the sheet P′ by the sheet binder 90, the clincher 91 descends and presses the corner of the sheet P′ between the clincher 91 and the face plate 92. At this time, the sheet binder 90 can be controlled not to perform a stapling operation (sheet binding operation) on the folded portion Pa′ not as in the regular binding mode, or can be controlled to perform the stapling operation (sheet binding operation) on the folded portion Pa′ as in the regular binding mode. The former case allows the consumption of staples to be reduced, and the latter case prevents the folded portion Pa′ from returning to the original state easily.

A description is given below of the operations of the post-processing apparatus 50 in the edge folding mode, with reference to FIGS. 5A, 5B and 5C.

When the “edge folding mode” is selected, the sheet P′ that is fed from the sheet trays 12, 13 and 14 of the image forming apparatus 1 is conveyed to the post-processing apparatus 50 at a timing designated by the user (in other words, to which sheet of the sheet bundle PT to be ejected and stacked on the second ejection tray 72 the sheet P′ as an index sheet is to be inserted). At this time, the image forming apparatus 1 can perform the above-described image forming process and print a desired image on the sheet P′ as an index sheet.

Then, the sheet P′ conveyed to the post-processing apparatus 50 is placed on the internal tray 61 as in the binding mode, although the number of sheets P′ is one. At this time, the shift roller pair 55 may not shift the sheet P′, or the shift roller pair 55 may shift the sheet P′ so that the sheet P′ that is finally used as an index sheet is set to shift in the width direction with respect to the other sheet bundles PT.

Then, as the sheet P′ is stacked on the internal tray 61, the tapping roller 63, which is disposed above the internal tray 61, is moved from the retracted position to the position at which the tapping roller 63 contacts the uppermost sheet P′, and is driven and rotated. By so doing, the uppermost sheet P′ is conveyed toward the end fence 66. At this time, the sheet P′ can be conveyed until the trailing end (trailing end in the conveyance direction) of the sheet P′ contacts the end fence 66, or the sheet P′ can be stopped at a position before the contact so that the sheet P′ that is finally as an index sheet is shifted in the conveyance direction with respect to the other sheet bundles PT. Further, when the shift roller pair 55 does not the sheet P′, the position of the sheet P′ in the width direction can be aligned at the center by the jogger fences 68 (side fences).

Further, at the timing when the sheet P′ is conveyed by the tapping roller 63 and the corner of the sheet P′ is inserted into the insertion portion 90a of the sheet binder 90 (standing by at the position illustrated in FIG. 4), the corner of the sheet P′ is folded back by the pushup member 64 that is raised in the direction indicated by the white arrow as illustrated in FIGS. 5A and 5B. Then, as illustrated in FIG. 5C, the portion folded back by the pushup member 64 is pressed between the clincher 91 and the face plate 92 with both of which being lowered, and the folded portion Pa′ is formed.

Then, the sheet P′ with the folded portion Pa′ is conveyed obliquely upward along the sloped face of the internal tray 61 along with movement of the ejection member 62, ejected to the outside due to conveyance by the ejection roller 54, stacked on the second ejection tray 72, and is placed on the sheet bundle PT (or the sheet P) that has already been stacked on the second ejection tray 72, so as to be used as an index sheet.

As described above, the post-processing apparatus 50 according to the present embodiment can form the folded portion Pa′ in a part of the sheet P′ by using the sheet binder 90 that is originally provided, and thus the post-processing apparatus 50 can be reduced in size and cost as compared with a case where a dedicated device for forming the folded portion Pa′ is provided.

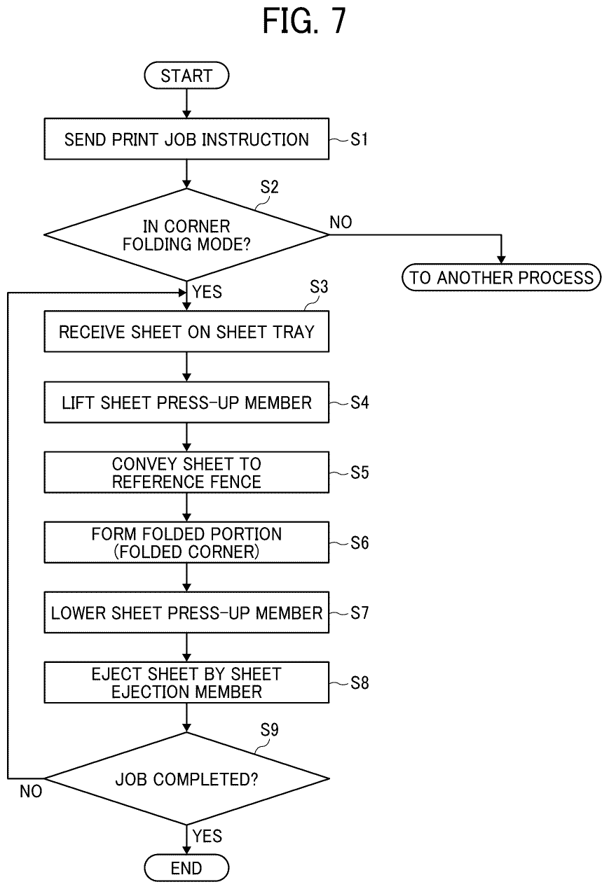

A description is given below of an example of control in the edge folding mode, with reference to a flowchart of FIG. 7.

FIG. 7 is a flowchart of an example of a control mode (edge folding mode) for forming the folded portion Pa on the sheet P.

First, when a print job instruction is sent by the user operating the operation display panel 49 (step S1), it is determined whether the edge folding mode is selected in the print job instruction (step S2).

When the edge folding mode is selected, the sheet P′ conveyed from the image forming apparatus 1 to the post-processing apparatus 50 is received on the internal tray 61 (sheet stacker) (step S3), the pushup member 64 (sheet pushup member) is raised from the reference position (the position illustrated in FIG. 5C) (step S4), the sheet P′ is conveyed to the position of the end fence 66 (reference fence) by the tapping roller 63, and the corner of the sheet P′ is curved (step S5). Then, the clincher 91 is lowered to press the curved portion against the face plate 92, so as to form the folded portion Pa′ (step S6). At this time, the pushup member 64 (sheet pushup member) is lowered to the reference position so as not to interfere with the formation of the folded portion Pa′ while maintaining the posture in which the sheet P′ is curved (step S7).

Then, the sheet P′ with the folded portion Pa′ is formed is conveyed by the ejection member 62, and the sheet P′ is ejected to the second ejection tray 72 (step S8).

Then, it is determined whether the series of jobs are completed (step S9). When the series of jobs are not completed (NO in step S9), the process goes back to step S3 to repeat steps from S3. When the series of jobs are completed (YES in step S9), the flow of the process ends.

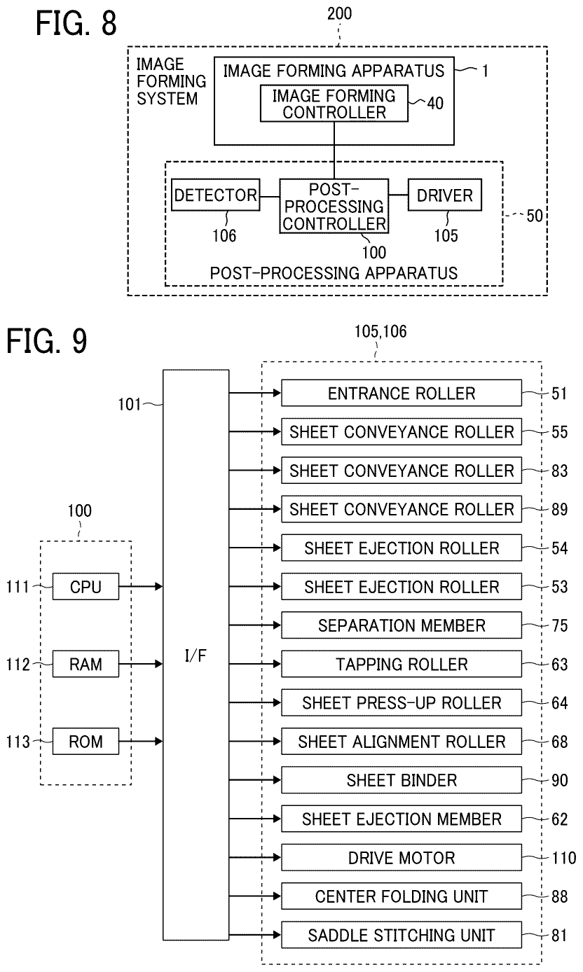

The image forming system 200 described above is controlled by a control system illustrated in FIG. 8, and the post-processing apparatus 50 is controlled by a control system illustrated in FIG. 9.

FIG. 8 is a block diagram illustrating a control system of the image forming system 200.

FIG. 9 is a block diagram illustrating a control system of the post-processing apparatus 50.

As illustrated in FIG. 8, the image forming apparatus 1 and the post-processing apparatus 50 are coupled to each other by an image forming controller 40 and a post-processing controller 100, respectively, so as to be able to communicate with each other. In the post-processing apparatus 50, a detector 106 that includes various sensors to detect the positions of sheets P and P′ and the mechanism, and a driver 105 that includes various actuators such as a drive motor 110 are connected to the post-processing controller 100. The post-processing controller 100 operates the driver 105 based on instructions, sheet size information, sheet thickness information, and image region information, which are sent from the image forming controller 40 of the image forming apparatus 1, and information on the states of the sheets P and P′ and the respective mechanisms sent from the detector 106, according to a program stored in the storage unit. By so doing, a desired post-processing operation is performed on the sheet P conveyed from the image forming apparatus 1.

As illustrated in FIG. 9, the post-processing controller 100 of the post-processing apparatus 50 includes, for example, a central processing unit (CPU) 111, a random access memory (RAM) 112, and a read-only memory (ROM) 113. The CPU 111 stores, for example, executable programs, and the RAM 112 and the ROM 113 form a storage unit. The CPU 111, the RAM 112 and the ROM 113 are connected to the respective members included in the detector 106 or the driver 105 via a communication interface 101.

### Modification 1

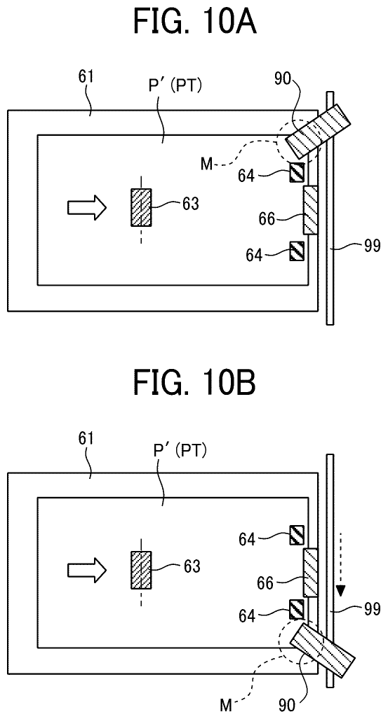

A description is given of the configuration of a post-processing apparatus 50 according to Modification 1 of the above embodiments of the present disclosure, with reference to FIGS. 10A and 10B.

FIGS. 10A and 10B are top views of the sheet binder 90 in a state where the corner of a sheet P′ is inserted to an insertion portion of the sheet binder 90 according to Modification 1.

As illustrated in FIGS. 10A and 10B, the post-processing apparatus 50 according to Modification 1 causes a movement mechanism described above with FIG. 4 to move the sheet binder 90 in the width direction (upward and downward directions in FIGS. 10A and 10B) so that the post-processing apparatus 50 can change the position to change the position in the width direction of the folded portion Pa′ formed in the sheet P′. In other words, the sheet binder 90 is movable in the width direction to change the position of the folded portion Pa′ on the part of the sheet P′ in the width direction.

In the example of FIGS. 10A and 10B, as the sheet binder 90 is moved to the position illustrated in FIG. 10A, the folded portion Pa′ can be formed at the corner on one end side in the width direction of the sheet P′ using a first pushup member 64 disposed in the vicinity of the sheet binder 90, and, as the sheet binder 90 is moved to the position illustrated in FIG. 10B, the folded portion Pa′ can be formed at the corner on the other end side in the width direction of the sheet P′ using a second pushup member 64 disposed in the vicinity of the sheet binder 90.

In the example of FIGS. 10A and 10B, when the sheet binder 90 at the position illustrated in FIG. 10A is moved to the position illustrated in FIG. 10B, a rotating mechanism (for example, a gear mechanism) rotates so that the orientation of the sheet binder 90 faces the corner at which the folded portion Pa′ is to be formed.

In a case of the configuration as described above, a folded portion Pa′ can be formed in a part of the sheet P′ without increasing the size and cost of the post-processing apparatus 50.

In particular, due to the configuration in which the position where the folded portion Pa′ is to be formed can be changed, multiple index sheets P′ having different forms can be created, enhancing the usability of the ear folding mode for the user.

### Modification 2

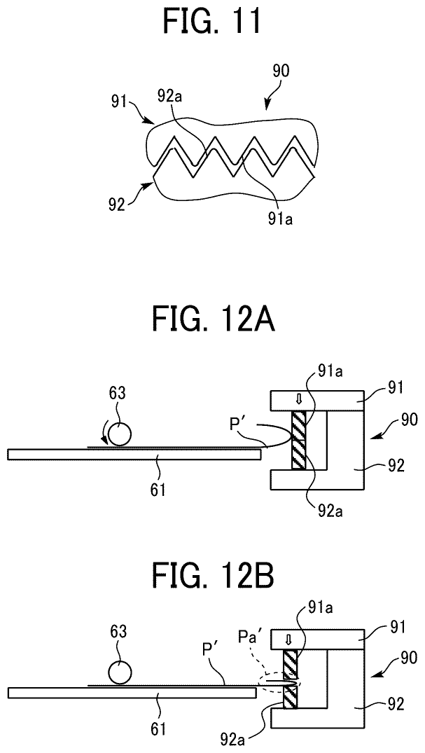

Referring to FIGS. 11, 12A and 12B, the post-processing apparatus 50 according to Modification 2 employs the stapleless sheet binder 90 as a sheet binder.

FIG. 11 is an enlarged view of a stapleless sheet binder according to Modification 2 in a state where paired tooth-shaped members in the stapleless sheet binder are engaged with each other.

FIG. 12A is a side view of the stapleless sheet binder of FIG. 11 in a state where the corner of a sheet is folded back by the stapleless sheet binder.

FIG. 12B is a side view of the stapleless sheet binder of FIG. 11 in a state where the folded portion of the sheet is formed.

The stapleless sheet binder 90 includes a pair of tooth-shaped members 91a and 92a that perform a sheet binding operation on the sheet bundle PT inserted to the insertion portion 90a, by moving (changing) from a state where the pair of tooth-shaped members 91a and 92a are separated from each other (non-meshed state) to a state where the pair of tooth-shaped members 91a and 92a are meshed (engaged) with each other (meshed state). Specifically, the stapleless sheet binder 90 performs the sheet binding operation on the sheet bundle PT stacked on the internal tray 61, without using a staple or staples. The stapleless sheet binder 90 performs the sheet binding operation by pressing the sheet bundle PT nipped by the pair of tooth-shaped members 91a and 92a having toothed uneven portions, forming unevenness in the thickness direction on the sheet bundle PT, and meshing (engaging) the sheets P with each other. The process of the sheet binding operation by the stapleless sheet binder 90 is substantially the same as the process of the sheet binding operation described above with reference to FIGS. 2, 5A, 5B and 5C, except for the difference between the device using a staple and the device not using a staple.

Further, in Modification 2, in the edge folding mode, as illustrated in FIG. 12A, the pair of tooth-shaped members 91a and 92a in the meshing state functions as a guide (sheet folder) that guides the sheet P′ to change the conveyance direction of the sheet P′ to be inserted into the insertion portion 90a (as an index sheet) and folds back a part (corner) of the sheet P′.

Specifically, when the “edge folding mode” is selected, like the operation described with reference to FIGS. 5A, 5B and 5C, as the sheet P′ is placed on the internal tray 61, the tapping roller 63 disposed above the sheet P′ is moved from the retracted position to the position at which the tapping roller 63 contacts the uppermost sheet P′, and is driven and rotated. By so doing, the uppermost sheet P′ is conveyed toward the end fence 66. Further, at the timing when the sheet P′ is conveyed by the tapping roller 63 and the corner of the sheet P′ is inserted into the insertion portion 90a of the sheet binder 90 (standing by at the position illustrated in FIG. 4), the upper tooth-shaped members 91a that are lowered in the direction indicted by white arrow are meshed with the lower tooth-shaped members 92a to form a wall (guide) extending in the vertical direction, and the corner of the sheet P′ is folded back by contacting the guide, as illustrated in FIG. 12A.

Then, as illustrated in FIG. 12B, the part of the sheet P′, which is folded back by the tooth-shaped members 91a and 92a in the meshed state is released and moved again to a substantially meshed state, is pressed between the pair of tooth-shaped members 91a and 92a, so that the folded portion Pa′ is formed.

At this time, the stapleless sheet binder 90 may perform the sheet binding operation on the sheet P′ already having the folded portion Pa′ of the sheet P′. In other words, the portion of the sheet P′ folded back by the pair of tooth-shaped members 91a and 92a in the meshed state are pressed between the pair of tooth-shaped members 91a and 92a that are released from the meshed state and are then shifted to the completely meshed state again, so that the stapleless sheet binder 90 performs the sheet binding operation on the folded portion Pa′. By thus performing the sheet binding operation, the folded portion Pa′ can be made less likely to return to the original state.

Then, the sheet P′ on which the folded portion Pa′ is formed is conveyed obliquely upward along the sloped face of the internal tray 61 along with movement of the ejection member 62, and is ejected onto the second ejection tray 72 by the ejection roller 54.

In a case of the configuration as described above, a folded portion Pa′ can be formed in a part of the sheet P′ without increasing the size and cost of the post-processing apparatus 50.

### Modification 3

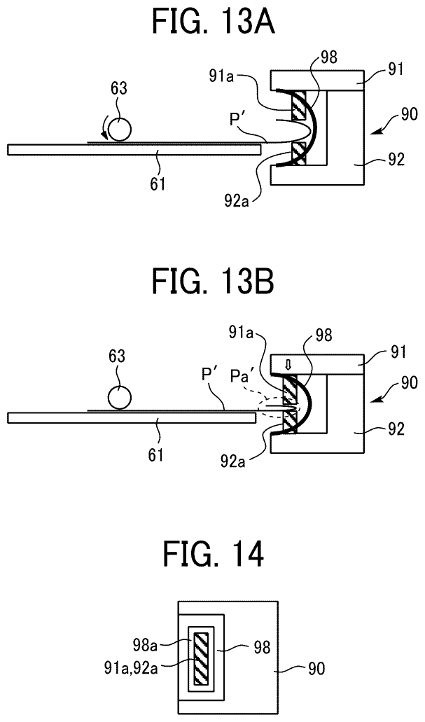

Referring to FIGS. 13A, 13B and 14, the post-processing apparatus 50 according to Modification 3 does not cause the pair of tooth-shaped members 91a and 92a in the meshed state of the stapleless sheet binder 90 to function as a guide to bend and fold the sheet P′ as described with reference to FIGS. 12A and 12B but employs a dedicated guide 98 disposed in the insertion portion 90a.

FIG. 13A is a side view of a stapleless sheet binder according to Modification 3 in a state where the corner of a sheet is folded back by the stapleless sheet binder.

FIG. 13B is a side view of the stapleless sheet binder according to Modification 3 in a state where the folded portion of the sheet is formed.

FIG. 14 is a cross-sectional view of an insertion portion of the stapleless sheet binder of FIGS. 13A and 13B viewed from above.

The guide 98 is a thin metal plate having the resiliency so that the curved posture (radius of curvature) changes along with the vertical movement of the upper tooth-shaped members 91a. The guide 98 is formed with a slit 98a that enables switching between the meshed state and the non-meshed state of the pair of tooth-shaped members 91a and 92a. Further, the guide 98 functions as a sheet folder that guides the sheet P′ so as to change the conveyance direction of the sheet P′ to be inserted into the insertion portion 90a of the sheet folder, and bends a part of the sheet P′.

Specifically, when the “edge folding mode” is selected, like the operation described with reference to FIGS. 12A and 12B, as the sheet P′ is placed on the internal tray 61, the tapping roller 63 disposed above the internal tray 61 is moved from the retracted position to the position at which the tapping roller 63 contacts the uppermost sheet P′, and is driven and rotated. By so doing, the uppermost sheet P′ is conveyed toward the end fence 66. At this time, the pair of tooth-shaped members 91a and 92a are in a non-meshed state, and the corner of the sheet P′ inserted into the insertion portion 90a is folded back while being guided by the guide 98.

Further, as illustrated in FIG. 13B, the pair of tooth-shaped members 91a and 92a are moved to substantially the meshed state to nip the portion of the sheet P′ that is folded back and press the portion of the sheet P′ between the pair of tooth-shaped members 91a and 92a, so that the sheet binder 90 forms the folded portion Pa′. At this time, the stapleless sheet binder 90 may perform the sheet binding operation on the sheet P′ already having the folded portion Pa′ of the sheet P′.

Then, the sheet P′ on which the folded portion Pa′ is formed is conveyed obliquely upward along the sloped face of the internal tray 61 along with movement of the ejection member 62, and is ejected onto the second ejection tray 72 by the ejection roller 54.

In a case of the configuration as described above, a folded portion Pa′ can be formed in a part of the sheet P′ without increasing the size and cost of the post-processing apparatus 50.

As described above, the post-processing apparatus 50 according to the present embodiment includes the sheet binder 90 that performs the sheet binding operation on the sheet bundle PT including multiple sheets P. The post-processing apparatus 50 can form a folded portion Pa′ in a part of the sheet P′ by the sheet binder 90 with respect to the sheet P′ conveyed toward the sheet binder 90.

Accordingly, the folded portion Pa′ can be formed in a part of the sheet P′ without increasing the size and cost of the post-processing apparatus 50.

In the present embodiment, the post-processing apparatus 50 coupled to the image forming apparatus 1 that performs monochrome image formation is applied to the present disclosure. However, the present disclosure is not limited to the above-described post-processing apparatus (the post-processing apparatus 50). For example, the present disclosure may also be applied to a post-processing apparatus coupled to an image forming apparatus that performs color image formation.

Further, in the present embodiment, the post-processing apparatus 50 coupled to the image forming apparatus 1 that employs electrophotography. However, the present disclosure is not limited to the above-described post-processing apparatus (the post-processing apparatus 50). For example, the present disclosure may also be applied to a post-processing apparatus coupled to an image forming apparatus that employs other types such as an inkjet image forming apparatus or a stencil printing machine.

Further, the present disclosure may also be applied not only to the post-processing apparatus 50 coupled to the image forming apparatus 1 but also to a post-processing apparatus as a standalone apparatus, for example, an apparatus with a sheet tray set to the sheet receiving port 50a and an operation display panel via which a mode such as a processing mode is input to the post-processing apparatus.

Further, in the present embodiment, the post-processing apparatus 50 coupled to the image forming apparatus 1 that performs sheet binding, sorting, saddle binding, center folding and punching processes. However, the present disclosure is not limited to the above-described post-processing apparatus (the post-processing apparatus 50). For example, the present disclosure may also be applied to a post-processing apparatus that performs a binding process only.

Further, in the present embodiment, the post-processing apparatus 50 forms a folded portion Pa′ at the corner of a sheet P. However, the present disclosure is not limited to the corner of a sheet P as a portion (part of the sheet P′) on which the folded portion Pa′ is formed. For example, the present disclosure may also be applied to a post-processing apparatus that includes the sheet binder 90 having the insertion portion 90a extending in the whole area in the width direction and forms a folded portion Pa′ over the entire region in the width direction of the trailing end of the sheet P′.

Such a coating device can achieve the same advantages as the advantages of the present embodiment.

The above-described embodiments and modifications are illustrative and do not limit this disclosure. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape are not limited to the embodiments and thus may be preferably set to be applied to the present disclosure.

In the present specification, the “sheet” serving as a recording medium or a medium includes any kinds of sheets on which a post-processing operation is formed.

### ASPECTS OF THE PRESENT DISCLOSURE

Aspects of the present disclosure are, for example, as follows.

### Aspect 1

In Aspect 1, a post-processing apparatus includes a sheet binder that performs a binding operation on a sheet bundle including multiple sheets, and causes the sheet binder to form a folded portion in a part of a sheet of the multiple sheets.

### Aspect 2

In Aspect 2, in the post-processing apparatus according to Aspect 1, the sheet binder perform a sheet binding operation on the corner of at least the sheet bundle, and forms a folded portion at the corner of the sheet conveyed to the sheet binder.

### Aspect 3

In Aspect 3, in the post-processing apparatus according to Aspect 1 or 2, the sheet binder includes a sheet folder that has an insertion portion to which a processing object of the sheet bundle is inserted to perform the sheet binding operation on the processing object. The sheet folder folds back a portion of the sheet conveyed to the sheet binder, and the sheet binder presses the folded portion of the sheet folded by the sheet folder to form the folded portion.

### Aspect 4

In Aspect 4, in the post-processing apparatus according to Aspect 3, the sheet folder is a pushup member that pushes up the sheet so as to change the conveyance direction of the sheet to be inserted into the insertion portion of the sheet binder, and bends a part of the sheet.

### Aspect 5

In Aspect 5, in the post-processing apparatus according to Aspect 3, the sheet folder is a guide that guides the sheet so as to change the conveyance direction of the sheet to be inserted into the insertion portion of the sheet binder, and bends a part of the sheet.

### Aspect 6

In Aspect 6, in the post-processing apparatus according to Aspect 5, the sheet binder is a stapleless sheet binder that includes a pair of tooth-shaped members that perform a sheet binding operation on a sheet bundle inserted into the insertion portion by moving (changing) from a state where the pair of tooth-shaped members are separated from each other. The guide is in the state where the pair of tooth-shaped members are meshed with each other.

### Aspect 7

In Aspect 7, in the post-processing apparatus according to any one of Aspects 1 to 6, the sheet binder performs the sheet binding operation on the folded portion of the sheet after the folded portion is formed.

### Aspect 8

In Aspect 8, in the post-processing apparatus according to any one of Aspects 1 to 7, a position in a width direction of the folded portion of the sheet is changeable as the sheet binder is moved in the width direction.

### Aspect 9

In Aspect 9, an image forming system includes an image forming apparatus that forms an image on a sheet, and the post-processing apparatus according to any one of Aspects 1 to 8 that performs a sheet binding operation on the sheet with the image formed by the image forming apparatus.

### Aspect 10

In Aspect 10, a post-processing apparatus includes a sheet binder to bind a sheet bundle including a sheet to perform a sheet binding operation. The sheet binder includes a sheet folder to fold a part of the sheet to form a folded portion on the sheet of the sheet bundle.

### Aspect 11

In Aspect 11, in the post-processing apparatus according to Aspect 10, the sheet folder of the sheet binder folds a corner of the sheet as the part of the sheet to form the folded portion. The sheet binder binds a part of the including the corner of the sheet of the sheet bundle to perform the sheet binding operation.

### Aspect 12

In Aspect 12, in the post-processing apparatus according to Aspect 10 or 11, the sheet folder has an insertion portion having an opening to accept a part of the sheet bundle inserted into the insertion portion to perform the sheet binding operation. The sheet folder folds back the part of the sheet inserted to the insertion portion of the sheet binder, and presses the part of the sheet folded back to form the folded portion.

### Aspect 13

In Aspect 13, in the post-processing apparatus according to Aspect 12, the sheet folder includes a pushup member to push up the part of sheet inserted into the insertion portion and to bend the part of the sheet to form the folded portion.

### Aspect 14

In Aspect 14, in the post-processing apparatus according to Aspect 12, the sheet folder includes a guide to change a conveyance direction of the part of the sheet inserted into the insertion portion to bend the part of the sheet.

### Aspect 15

In Aspect 15, in the post-processing apparatus according to Aspect 14, the sheet binder includes a stapleless sheet binder including a pair of tooth-shaped members. The pair of tooth-shaped members performs the sheet binding operation on the sheet bundle inserted into the insertion portion. The guide includes the pair of tooth-shaped members engaged with each other.

### Aspect 16

In Aspect 16, in the post-processing apparatus according to any one of Aspects 10 to 15, the sheet binder performs the sheet binding operation on the folded portion after forming the folded portion on the part of the sheet.

### Aspect 17

In Aspect 17, in the post-processing apparatus according to any one of Aspects 10 to 16, the sheet binder is movable in a width direction of the sheet, to change a position of the folded portion on the part of the sheet in the width direction.

### Aspect 18

In Aspect 18, an image forming system includes an image forming apparatus to form an image on a sheet, and the post-processing apparatus according to any one of Aspects 10 to 17 to perform a sheet binding operation on which the image is formed by the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

What is claimed is:

1. A post-processing apparatus comprising:
a sheet binder to bind a sheet bundle including a sheet to perform a sheet binding operation,
wherein the sheet binder includes a sheet folder to fold a part of the sheet to form a folded portion on the sheet of the sheet bundle.

2. The post-processing apparatus according to claim 1,
wherein the sheet folder of the sheet binder folds a corner of the sheet as the part of the sheet to form the folded portion, and
the sheet binder binds a part of the including the corner of the sheet of the sheet bundle to perform the sheet binding operation.

3. The post-processing apparatus according to claim 1,
wherein the sheet folder has an insertion portion having an opening to accept a part of the sheet bundle inserted into the insertion portion to perform the sheet binding operation, and
the sheet folder:
folds back the part of the sheet inserted to the insertion portion of the sheet binder; and
presses the part of the sheet folded back to form the folded portion.

4. The post-processing apparatus according to claim 3,
wherein the sheet folder includes a pushup member to push up the part of sheet inserted into the insertion portion and to bend the part of the sheet to form the folded portion.

5. The post-processing apparatus according to claim 3,
wherein the sheet folder includes a guide to change a conveyance direction of the part of the sheet inserted into the insertion portion to bend the part of the sheet.

6. The post-processing apparatus according to claim 5,
wherein the sheet binder includes a stapleless sheet binder including a pair of tooth-shaped members,
the pair of tooth-shaped members performs the sheet binding operation on the sheet bundle inserted into the insertion portion, and
the guide includes the pair of tooth-shaped members engaged with each other.

7. The post-processing apparatus according to claim 1,
wherein the sheet binder performs the sheet binding operation on the folded portion after forming the folded portion on the part of the sheet.

8. The post-processing apparatus according to claim 1,
wherein the sheet binder is movable in a width direction of the sheet,
to change a position of the folded portion on the part of the sheet in the width direction.

9. An image forming system comprising:
an image forming apparatus to form an image on a sheet; and
the post-processing apparatus according to claim 1 to perform a sheet binding operation on the sheet on which the image is formed by the image forming apparatus.
